(19) United States
(12) Patent Application Publication
(10) Pub. No.: US 2008/0168137 A1
(43) Pub. Date: Jul. 10, 2008

(54) CONTINUING EDUCATION PORTAL

(76) Inventors: Ray Benza, Birmingham, AL (US); Edwina Benza, Birmingham, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/970,478

(22) Filed: Jan. 7, 2008

Related U.S. Application Data
(60) Provisional application No. 60/878,937, filed on Jan. 8, 2007.

(51) Int. Cl. G06F 15/16; G06Q 30/00; G06Q 99/00

(52) U.S. Cl. 709/204; 705/14; 705/1

(57) ABSTRACT

A system of providing remote access to conferences having a plurality of live conference sessions presented by a presenter includes a content provider creating a virtual conference session by capturing the live session. A conference provider receives and aggregates the virtual conference sessions, and then transmits the virtual conference sessions to a session station. A participant accesses the virtual conference session through an output device on the session station. A network is utilized for communications between the content providers, the conference provider, and the session stations.

### BACKGROUND OF THE INVENTION

(1) Field of the Invention

The current invention relates to conference or meeting presentations transmitted through electronic media.

(2) Description of the Related Art

There is a strong desire and need to improve both the “meeting experience” and technology for professional informational meetings. Many people, such as physicians and other professionals, are limited by time, work schedules, finances, or even threat of terrorism. For these and other reasons, many have stopped going to meetings yet still desire the information. Such meetings are still presented, but new delivery formats are required to meet this need. Currently, the only available format is purchasing a pre-made CD Rom of selected sessions at a premium price, which is offered by the conference organizers.

### BRIEF SUMMARY OF THE INVENTION

Embodiments of the invention provide a new service at conferences to bring live sessions in a real-time environment to interested individuals at their location of choice: office, home, hotel, etc. A key feature of this interaction is to preserve the “real-time” speaker-attendee communication, which is the essence of a true meeting experience. The current invention provides the unique ability of the viewer/attendee, or the participant, to address questions or comments to the speaker real-time, and thus to generate a rapid response for the participant asking the question, as well as all other participants. This will spark a level of enthusiasm that goes beyond the simple viewing of even a live session, thus preserving the integrity of the meeting experience.

Embodiments of the invention allow a real-time presentation to be broadcast on the web or other media, and allow the attendee to be seen and heard directly by the speaker, session moderator, or the conference audience on demand via webcam or audio. These embodiments may also allow the attendee to type in comments or questions to the session moderator or the speaker if the participant so chooses, or if webcam or audio is not available on his or her equipment.

The current system provides for remote access to conferences having a plurality of live conference sessions, with each conference session being presented by a presenter. A content provider captures and transmits the live conference session real time, and thus produces a virtual conference session. The virtual conference sessions are transmitted to a conference provider, who receives and aggregates the virtual conference sessions. A participant accesses a virtual conference session using a session station, which receives the virtual conference session from the conference provider. A network is utilized for communications between the content provider, the conference provider, and the session station.

### BRIEF DESCRIPTION OF THE DRAWINGS

Many of the attendant advantages of the invention will become more readily appreciated as the same becomes better understood with reference to the following detailed description, when taken in conjunction with the accompanying drawings, briefly described here.

FIG. 1 is a functional block diagram generally illustrating functional components of a continuing education portal, in accordance with one embodiment of the invention.

FIG. 2 is a functional block diagram of an exemplary computing device that may be used to implement one or more embodiments of the invention.

FIG. 3 is a graphical representation of a display that may be presented by a conference provider in collaboration with content providers.

FIG. 4 is a graphical representation of another display that may be presented by a conference provider in collaboration with content providers.

FIG. 5 is an operational flow diagram generally illustrating a process for presenting multiple conference sessions remotely over a network, in accordance with one implementation of the invention.

Embodiments of the invention will now be described in detail with reference to these Figures in which like numerals refer to like elements throughout.

### DETAILED DESCRIPTION

Various embodiments are described more fully below with reference to the accompanying drawings, which form a part hereof, and which show specific exemplary implementations for practicing various embodiments. However, other embodiments may be implemented in many different forms and the invention should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Generally stated, the described embodiments include mechanisms and techniques for remote location, real time viewing/interactive meetings and/or intra meeting “session surfing” at multi-session conferences and/or seminars. For example, the annual American Heart Association Meeting hosts hundreds of simultaneous sessions categorized under various topics of interests and specialties. Each session typically contains nine to ten 15-minute lectures. Due to the simultaneous timing of and physical distance (often at the opposing end of the convention center or at a nearby hotel) between sessions, attendees often have to sacrifice one session of interest for another. In addition, many physicians may wish to only hear a portion of the lecture series (ex. No. 1-5, 7, 9) in one location and lecture No 6 in another locale, but it's too far away to slip back and forth between sessions without missing the tail end of the original lecture series. Embodiments of the invention provide intra-meeting accessibility to all the sessions, so that an attendee in one session can log on with their laptop and view/listen to a lecture in another room without leaving the first session.

In addition, lounges may also be developed to allow participants to stay in an open locale and “surf” the entire meeting and virtually attend only the lectures they want to hear in each of the sessions. Included is the ability to pose questions to the lecturer via remote communication or web camera.

The components illustrated in the figures are functional in nature, and may or may not directly correspond to physical manifestations in actual embodiments. In other words, components illustrated and described as a single computing component may in actuality be implemented as a single component or, alternatively, as components distributed over multiple computing systems. And conversely, functionality illustrated as distributed over multiple components in these embodiments in actuality, may be implemented on a single computing system.

### Illustrative Systems

The principles and concepts will first be described with reference to a sample system that implements certain embodiments of the invention. This sample system may be implemented using conventional or special purpose computing equipment programmed in accordance with the teachings of these embodiments.

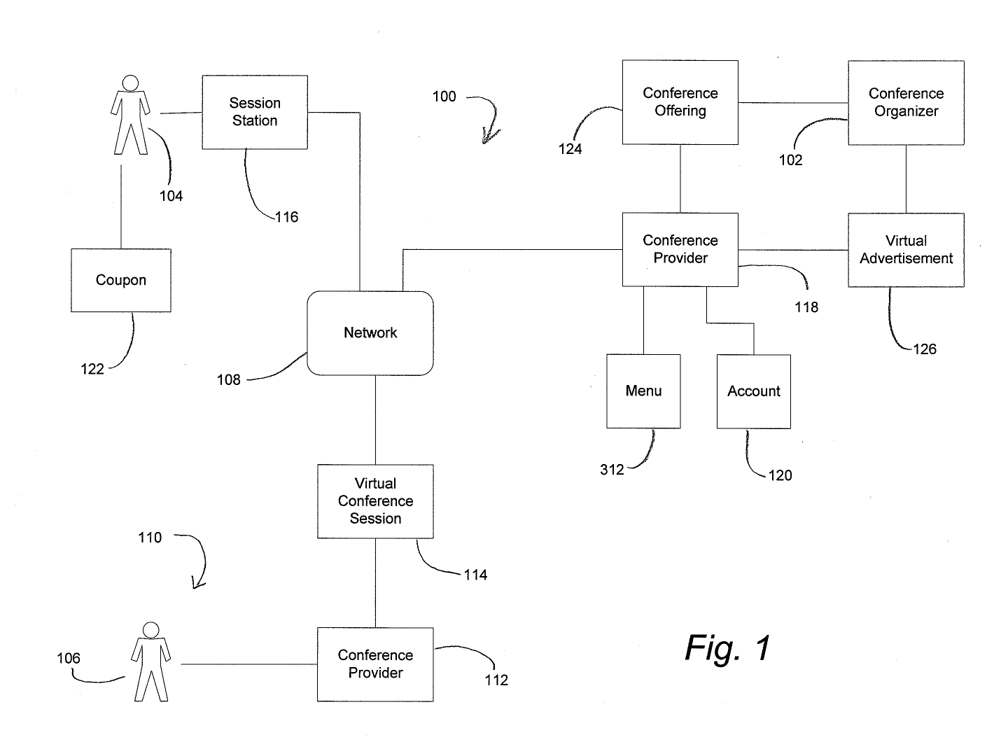

FIG. 1 is a functional block diagram generally illustrating a system 100 for enabling a multi-session conference portal providing remote access as desired. As illustrated in FIG. 1, the system 100 includes a conference organizer 102, a participant 104, and a presenter 106. Each of these entities utilizes a computer or other electronic device to communicate through a network 108.

The conference includes a plurality of presenters 106 conducting live conference sessions 110, which are captured and transmitted real time by a content provider 112. The content provider 112 can be a computer system with a video recording/transmitting device, a microphone, or some other means of capturing and transmitting the live conference session, and the captured live conference session 110 is referred to as a virtual conference session 114. The content provider 112 can just capture and transmit the virtual conference session 114, but it may also be possible for the content provider 112 to record the virtual conference session 114 for later viewing.

The participant 104 utilizes a session station 116, which is an electronic viewing system such as a computer, to view or monitor the virtual conference session 114. The session station 116 includes an output device of some sort for presenting a virtual conference session 114 to the participant 104. The conference organizer 102 utilizes a conference provider 118 to electronically communicate with the session station 116 and the content provider 112. The conference provider 118 receives the virtual conference sessions 114 from the content provider 112 for real time transmittal to participants 104. It is also possible for the conference provider 118 to simultaneously record virtual conference sessions 114 for later viewing. The components illustrated in FIG. 1 are illustrative only and are provided for the purpose of describing the functionality implemented in one embodiment. Many other embodiments may be implemented with components that differ in detail from those described here.

In this embodiment, each of the components 112, 116, & 118 communicates with each other over a network 108, such as the Internet or a local area network. As described more fully below, the system 100 enables the participant 104 to access one or more of several live or recorded virtual conference sessions 114 captured by the content provider 112 and served by the conference provider 118.

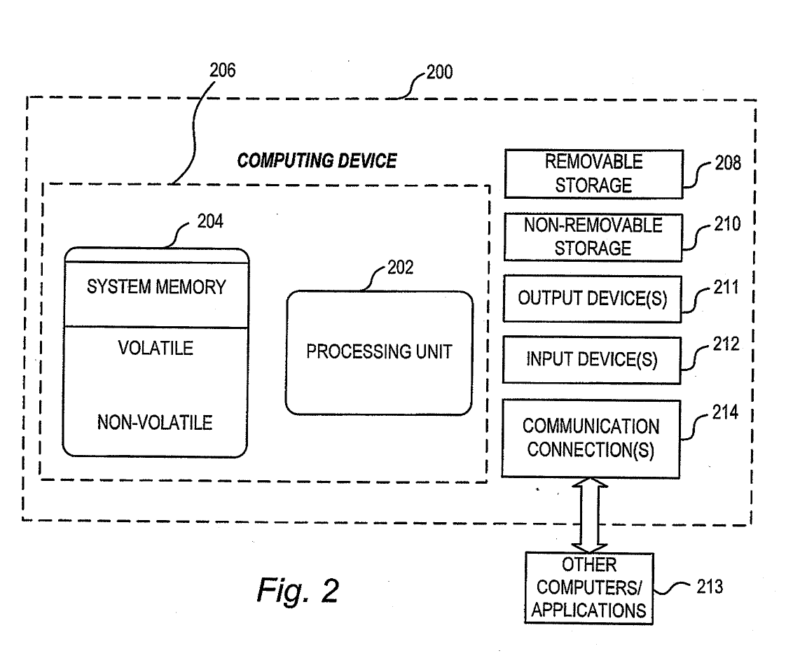

The conference provider 118 represents a computer system operated by a conference organizer 102, which is typically a business enterprise, non-profit organization, government agency, or other entity that provides remote conferencing services over the network 108. The conference provider 118 may be implemented as any conventional computing system, such as the system illustrated in FIG. 2 and described below, and includes communication software for communicating with other computers over a network. The conference provider 118 may also include messaging components for receiving electronic messages, such as email, instant messages, electronic faxes, or the like.

The conference provider 118 facilitates remote conferences between a conference organizer 102 and the participant 104, wherein the participant 104 is generally a person. Generally stated, the conference provider 118 offers its users the ability to connect to a remotely-accessible location, such as a Web site, and view a conference that is being presented by a conference organizer 102. Conventional systems have been limited to a one-to-many session paradigm, where one conference organizer 102 broadcasts a remote conference to many participants 104. However, this embodiment of the invention improves on these conventional systems by enabling a conference organizer 102 to broadcast (or offer to broadcast) a selection of multiple remote virtual conference sessions 114 from which participants 104 may select.

The participant 104 utilizes a session station 116 to view and optionally to participate in a remote live conference session 110. The participant 104 can direct questions to the presenter 106 during the live conference session 110 through the network 108, and the presenter 106 is able to respond to the question for the benefit of the participant 104 and everyone else considering a similar question. In one embodiment, the session station 116 includes browsing software that enables access to web pages or the like over the network 108, or perhaps over alternate networks. For example, if the virtual conference sessions 114 were transmitted over a local area network, the session station 116 may be able to access web pages or the like over the internet. In other embodiments, the session station 116 includes messaging software, such as e-mail or instant messaging software, operative to transmit and/or receive electronic messages. The session station 116 may connect to other computing systems over the network 108 using conventional wired or wireless technology, depending only on the limitations of the particular implementation.

The content provider 112 is a computing system or collection of components operated by the conference organizer 102, where the conference organizer 102 is an entity that provides content aggregation and delivery services. In this particular embodiment, the content provider 112 is operated separately from the conference provider 118. However, in other embodiments, the content provider 112 could be implemented as a part of the conference provider 118.

The content provider 112 is coupled to the network 108 and includes image capturing components, such as a Web camera or other audio/video image capturing hardware. The content provider 112 may be implemented as multiple different computing systems located in relation to multiple live conference sessions 110, such as at a conference. Each content provider 112 is operative to capture, in real time, the live conference session 110 as it is occurring and in the location where it is occurring. In one example, the content provider 112 may be a laptop or other mobile computing device outfitted with a Web cam for capturing a live conference session 110. Each content provider 112 is also operative to connect with the conference provider 118 and upload/deliver the virtual conference session 114 to the conference provider 118.

In operation, the system 100 enables multiple content providers 112 to be located in proximity to each at several live conference sessions 110. Each content provider 112 uploads or delivers a virtual conference session 114 to a common service provider account at the conference provider 118. The participant 104 logs in to the conference provider 118 and accesses a conference offering 124 using the session station 116 and common service provider account information, which is maintained in the participant's account 120. The participant 104 is then presented with an option of selecting from the multiple virtual conference sessions 114 being delivered by the multiple content providers 112. In this way, a participant 104 can more easily select which of multiple virtual conference sessions 114 to attend/view without being concerned with the location of the live conference session 110. When coupled with the feature of recording a virtual conference session 114, the participant 104 can even attend/view a desired virtual conference session 114 regardless of when it occurs, and this can be done at a remote location including home, office or hotel. In other words, a participant 102 could log in to the conference provider 118 and select to record one or several of the multiple virtual conference sessions 114 being captured by the content providers 112.

FIG. 2 is a functional block diagram of an exemplary computing device 200 that may be used to implement one or more embodiments of the invention, such as the components described above. The computing device 200, in one basic configuration, includes at least a processing unit 202 and memory 204. Depending on the exact configuration and type of computing device, memory 204 may be volatile (such as RAM), non-volatile (such as ROM, flash memory, etc.) or some combination of the two. This basic configuration is illustrated in FIG. 2 by dashed line 206.

Additionally, device 200 may also have other features and functionality. For example, device 200 may also include additional storage (removable and/or nonremovable) including, but not limited to, magnetic or optical disks or tape. Such additional storage is illustrated in FIG. 2 by removable storage 208 and nonremovable storage 210. Computer storage media includes volatile and nonvolatile, removable and non-removable media implemented in any method or technology for storage of information such as computer readable instructions, data structures, program modules or other data. Memory 204, removable storage 208 and nonremovable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and can accessed by device 200. Any such computer storage media may be part of device 200.

Computing device 200 includes one or more communication connections 214 that allow computing device 200 to communicate with one or more computers and/or applications 213. Device 200 may also have input device(s) 212 such as keyboard, mouse, pen, voice input device, touch input device, etc. Output device(s) 211 such as a monitor, speakers, printer, PDA, mobile phone, and other types of digital display devices may also be included. These devices are well known in the art and need not be discussed at length here.

The principles and concepts introduced above will now be described with reference to sample graphical displays that may be presented by the conference provider 118 to participants 104 at login.

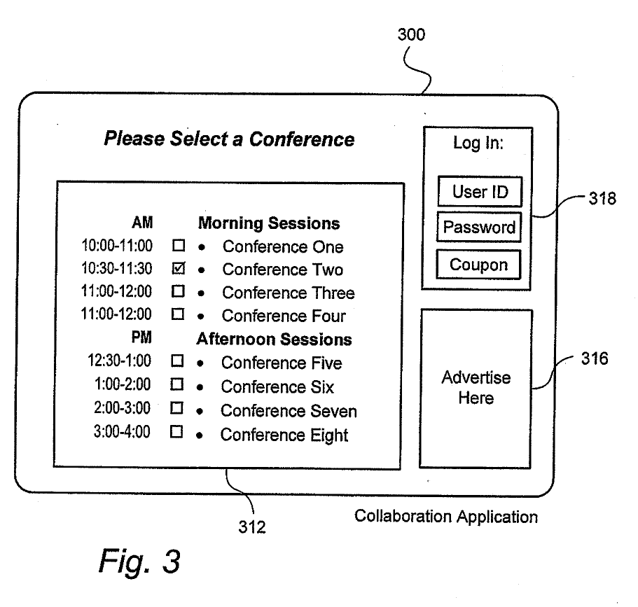

FIG. 3 is a graphical representation of a display 300 that may be presented by the conference provider 118 in collaboration with the content providers 112, as seen by referring to both FIGS. 1 and 3. The display 300 includes a login portion 318 that allows participants to login using a user name 320 or user ID 320 and password 322 combination. The conference organizer 102 issues a unique user name 320 and password 322 to each participant 104, and the user name 320 and password are recorded in the participant's account 120. This unique user name 320 and password 322 identifies the participant 104, so the participant 104 can use different session stations 116 and still be uniquely recognized by the conference provider 118.

The login portion 318 may additionally allow users to enter coupon information. For example, large conferences may hand out or otherwise make available coupons 122 or cards 122 with information that enables conference participants 104 to login and view various individual virtual conference sessions 114 being offered at the seminar. The conference organizer 102 may categorize different virtual conference session 114 into a plurality of different virtual conference session categories and enter the categorization information into the conference provider 118. Different conditions or terms can be imposed to on a participant 104 view the different conference session categories, such as different prices or access privileges. The different access privileges can be signified and therefore provided by a coupon 122, which serves to identify the participant 104 as one with the necessary access privileges for viewing a particular conference session category.

An alternate means of providing access to a conference is with the use of pre-paid user's cards. Increased revenue can be generated through the use of pre paid user's cards, which can be purchased by the end users themselves, or by third parties who then provide them to the end users, either for a fee, as a gift, or as an advertising method. These pre paid cards or units can include the emblems or other marks or logos of the third parties, which can serve as advertisements for the third party. The pre paid user cards can entitle the participant 104 to a reduced price for a virtual conference session 114 or for an entire conference offering 124, and often the price would be reduced to zero.

The display 300 also includes a listing 312 or menu 312 of each individual meeting being offered by the particular conference organizer 102. For instance, at a large seminar, many different live conference sessions 10 may be offered, and some may overlap or otherwise be impossible to view simultaneously. To address this situation, the conference organizer 102 presents the menu 312 of all the virtual conference sessions 114 that the participant 104 may view, with their respective live times. The participant 104 may select, such as using a check box or the like, which of the several virtual conference sessions 114 to view. The participant 104 may also select to record a particular virtual conference session 114 if two or more desired conference sessions overlap, or if the participant 104 desires to view a virtual conference session 114 at a later time for any other reason.

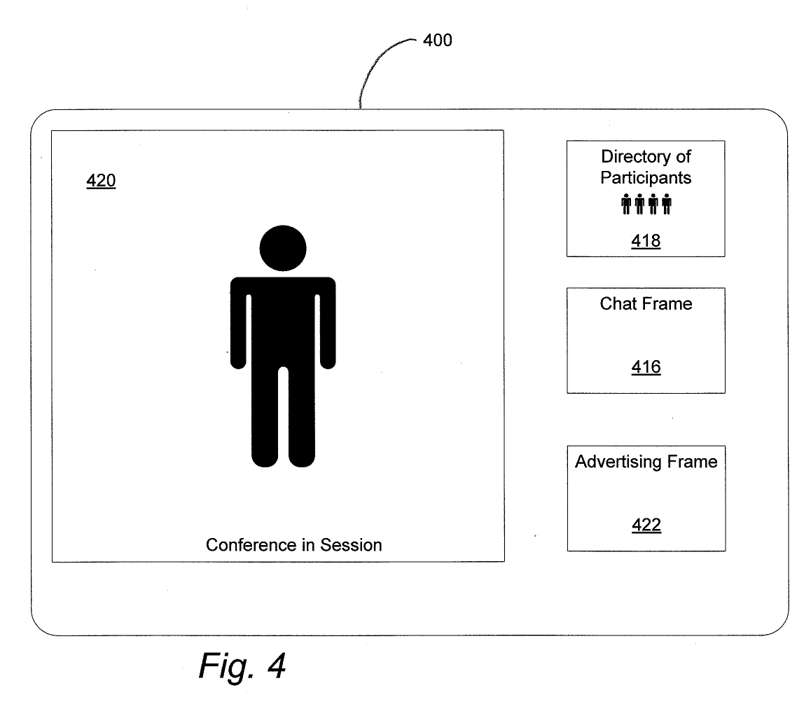

Referring to FIG. 4 and FIG. 1, a graphical representation of another display 400 that may be presented by the conference provider 118 in collaboration with the content providers 112 is shown. In this display 400, a participant 104 has logged in to one of multiple virtual conference sessions 114 being presented by a conference organizer 102. The virtual conference session 114 is displayed in a primary frame 420 of the display 400. Another frame 418 optionally may be used to identify each of the individuals or participants 104 that have logged in to this particular virtual conference session 114. This frame 418 used to identify participants 104 logged in to a particular virtual conference session 114 is referred to as a directory of participants 418. In addition, a chat frame 416 could be used to enable one participant 104 to communicate with different participants 104 during the virtual conference session 114 using chat technology.

An advertising frame 422 could be employed in the display 400 to enable revenue generation through remote advertising. Alternatively, the advertising frame 418 could be used for co-branding of remote conferences, such as for displaying information about the conference. The advertising frame could be included in the chat frame 416, or the advertising could be displayed in almost any conceivable method within the display 400. This could include streaming advertising to participants 104 while they are using the chat frame 416. The conference organizer 102 could contract with various vendors to place virtual advertisements 126 on the display 400 in one manner or another. The advertisements would be transmitted by the conference provider 118 to the session stations 116 simultaneous with the transmittal of a virtual conference session 114.

### Illustrative Processes

The principles and concepts will now be described with reference to sample processes that may be implemented by a computing device, such as the computing device illustrated in FIG. 2, in certain embodiments of the invention. The processes may be implemented using computer-executable instructions in software or firmware, but may also be implemented in other ways, such as with programmable logic, electronic circuitry, or the like. In some alternative embodiments, certain of the operations may even be performed with limited human intervention. Moreover, the process is not to be interpreted as exclusive of other embodiments, but rather is provided as illustrative only.

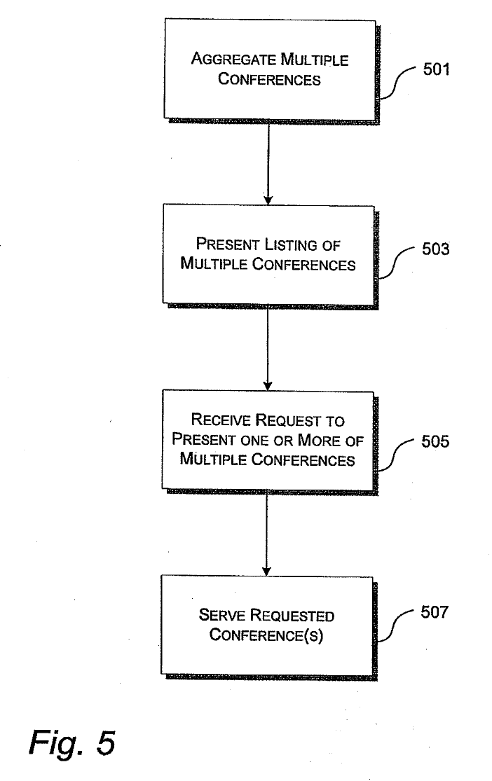

FIG. 5 is an operational flow diagram generally illustrating a process for making multiple virtual conference sessions 114 available remotely over a network 108, in accordance with one implementation of the invention, making reference to both FIGS. 1 and 5. The process begins at block 501, where a conference organizer 102 aggregates multiple virtual conference sessions 114 to produce a conference offering 124. Unlike existing technologies, where online conferencing services employ a one-to-many presentation paradigm, this implementation of the invention embodies a many-to-many paradigm in which multiple virtual conference session 114, perhaps even simultaneous, are aggregated into a single conference offering 124.

At block 503, a menu 312 of the multiple aggregated virtual conference sessions 114 is presented. For example, a conference provider 118 may make access available to participants 104 over a network 108. The conference provider 118 may present the listing of virtual conference sessions 114 to participants 104 that log in over the network 108. Those participants 104 logging in over the network 108 may then browse the menu 312 of virtual conference sessions 114 and select one or more desired virtual conference sessions 114.

At block 505, a request to present one or more desired virtual conference sessions 114 is received. Typically, the request takes the form of a selection made by a logged-in participant 104 after reviewing the menu 312. In one particular implementation, a check box or the like identifies one or more desired virtual conference sessions 114 from the menu 312. The participant 104 may select a “submit” button, or the like, to transmit the request to the conference provider 118.

At block 507, the requested virtual conference session 114 is transmitted to the participant's session station 116 by the conference provider 118 for viewing by the participant 104. In one implementation, the requested virtual conference session 114 is streamed live over the network 108 to the participant's session station 116. In this way, a participant 104 can relax in any network-accessible location and leisurely view the virtual conference session 114 of his or her choice. It is possible for the participant 104 to choose a virtual conference session 114, and then choose to view the virtual conference session 114 real time, or to record the virtual conference session 114 for latter viewing. If the participant 104 chooses to record the virtual conference session 114, the conference provider 118 records the virtual conference session 114 for later viewing by the participant 104. This allows the participant 104 to watch or participate in two or more virtual conference sessions 114 that overlap.

Reference has been made throughout this specification to “one embodiment,” “an embodiment,” or “an example embodiment” meaning that a particular described feature, structure, or characteristic is included in at least one embodiment. However, such phrases may refer to more than just one embodiment. Likewise, the described features, structures, or characteristics may be combined in any suitable manner in one or more embodiments. One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A system for providing remote access to conferences, comprising:
a plurality of live conference sessions presented by a presenter;
a virtual conference session;
a content provider comprised of a transmitting device to create the virtual conference session by capturing the live conference session;
a conference provider comprised of a computer which receives the virtual conference sessions, aggregates the virtual conference sessions to produce a conference offering, and transmits virtual conference sessions;
a session station for use by a participant, wherein the session station includes an output device and the participant is a person, and wherein the participant accesses the conference offering to select desired virtual conference sessions to be transmitted to the session station for viewing by the participant; and
a network, wherein the content provider, the conference provider, and the session station communicate through the network.

2. The system for providing remote access to conferences of claim 1 wherein the participant directs questions to the presenter through the network during the live conference session, and the presenter responds to the questions.

3. The system for providing remote access to conferences of claim 1 further comprising advertisements, wherein the conference provider transmits advertisements to the session station simultaneous with the transmission of the virtual conference session.

4. The system for providing remote access to conferences of claim 1 further comprising a plurality of virtual conference sessions categories, wherein different virtual conference session categories require different terms for access by a participant.

5. The system for providing remote access to conferences of claim 4 further comprising coupons, wherein the coupons provide access to different virtual conference session categories.

6. The system for providing remote access to conferences of claim 1 further comprising a user name and a password issued to the participant by the conference organizer.

7. The system for providing remote access to conferences of claim 1 further comprising pre-paid user cards, wherein the pre-paid user cards entitle the participant to a reduced price for a virtual conference session.

8. The system for providing remote access to conferences of claim 7 wherein the pre-paid user card includes an emblem of a third party.

9. The system for providing remote access to conferences of claim 1 further comprising a chat frame provided to the session station, wherein the chat frame allows different participants to communicate between themselves while viewing a virtual conference session.

10. The system for providing remote access to conferences of claim 1 wherein the participant selects virtual conference sessions for the conference provider to record for the participant.

11. The system for providing remote access to conferences of claim 1 further comprising a directory of participants transmitted with the virtual conference session to the session station.

12. A method of providing remote access to conferences comprising:
(a) capturing a plurality of live conference sessions to produce a plurality of virtual conference sessions;
(b) transmitting the virtual conference sessions to a conference provider;
(c) aggregating the virtual conference sessions by the conference provider to produce a conference offering, wherein the conference provider is comprised of a computer;
(d) accessing the conference offering by a participant having an account;
(e) selecting at least one virtual conference session by the participant, wherein the virtual conference session is selected from the conference offering; and
(f) transmitting the selected virtual conference session to a session station for viewing by the participant.

13. The method of providing remote access to conferences of claim 12 wherein step (c) further comprises:
categorizing the virtual conference sessions into different conference session categories, where such categorization is performed by a conference organizer; and
offering different conditions for viewing of virtual conference sessions from different conference session categories.

14. The method of providing remote access to conferences of claim 13 wherein the different conditions include different prices.

15. The method of providing remote access to conferences of claim 13 wherein the different conditions include different access privileges.

16. The method of providing remote access to conferences of claim 15 wherein the different access privileges are provided by a coupon.

17. The method of providing remote access to conferences of claim 12 wherein step (f) further comprises transmitting advertising to the participant by the conference provider simultaneous with the virtual conference session.

18. The method of providing remote access to conferences of claim 12 further comprising providing a chat frame for the participant, wherein different participants can communicate using the chat frame during a virtual conference session.

19. The method of providing remote access to conferences of claim 12 wherein step (e) further comprises the participant selecting virtual conference sessions to be recorded for later viewing.

20. A system for providing remote access to conferences, comprising:
a plurality of live conference sessions presented by a presenter;
a virtual conference session;
a content provider to create the virtual conference session by capturing the live conference session;
a conference provider comprised of a computer which receives the virtual conference sessions, aggregates the virtual conference sessions to produce a conference offering having different virtual session categories, transmits virtual conference sessions, and records virtual conference sessions;
a session station for use by a participant, wherein the session station includes an output device and the participant is a person, and wherein the participant accesses the conference offering to select desired virtual conference sessions to be transmitted to the session station for viewing by the participant, and the participant selects virtual conference sessions to be recorded for later viewing;
a network, wherein the content provider, the conference provider, and the session station communicate through the network.
a directory of participants provided with the virtual conference session;
a chat frame provided with the virtual conference session, wherein the chat frame allows different participants to communicate during the virtual conference session; and
a means for providing access to different virtual conference session categories.
